(19) United States
(12) Patent Application Publication
(10) Pub. No.: US 2026/0061711 A1
(43) Pub. Date: Mar. 5, 2026

(54) INFLATOR INTELLIGENT TIRE REPAIR CONTROL METHOD

(71) Applicant: DONGGUAN HESHENG MACHINERY & ELECTRIC CO., LTD., Dongguan City, Guangdong Province (CN)

(72) Inventor: Chi-Wen Chen, New Taipei City (TW)

(21) Appl. No.: 18/824,946

(22) Filed: Sep. 5, 2024

(51) Int. Cl. B29C 73/16; B60C 25/00; B29L 30/00

(52) U.S. Cl. CPC B29C 73/166; B60C 25/16; B29L 2030/00

(57) ABSTRACT

An inflator intelligent tire repair control method includes: powering on an inflator and detecting a tire pressure as a first tire pressure value before an inflation motor is activated; detecting again the tire pressure as a second tire pressure value after the inflation motor of is activated; calculating a pressure difference by subtracting the first tire pressure value from the second tire pressure value, and executing an inflation mode when the pressure difference is less than or equal to a minimum preset tire pressure value and executing a tire repair mode when the pressure difference is greater than a lowest tire pressure judgement value and less than a highest tire pressure judgement value. As such, the inflator is provided with an automatic judgement and switching mechanism between the inflation mode and the tire repair mode to avoid poor or incorrect operation by a user.

### BACKGROUND OF THE INVENTION

### (a) Technical Field of the Invention

The present invention relates to an inflator intelligent tire repair control method, and more particularly to an inflator tire repair control method having an automatic switching mechanism for an inflation mode and a tire repair mode.

### (b) Description of the Prior Art

Inflators can be mainly used in pneumatic tools, car tires or various inflatable appliances, and so on, as a source of gas. Therefore, in the field of do-it-yourselves (DIY), the role of inflators is a necessary tool for home repairs, and in addition, the current inflator equipment is also the main inflator equipment for vehicle tires.

Further, for new cars purchased today, when the vehicles leave the factory, they are equipped with a vehicle tire inflator to inflate the tires when the tire pressure is insufficient. In addition, accompanying with this type of inflator equipment, an additional set of tire repair chemical can is provided, in order to allow for self-performance of emergency tire repair rescue measures in case the tire is punctured and damaged.

However, to carry out emergency tire repair and rescue work by oneself, the tire repair chemical can must be used and operated in conjunction with the tire inflator to complete the perfect tire repair and rescue work. There are indeed some relatively high technical procedures involved in these operations, such as pressure control of the tire inflator, arrangement of the tire repair chemical can, and the activation and shutdown of the inflator, and so on, all being related to the success of the tire repair rescue.

In addition, since car tire repair rescue measures do not happen often, once emergency rescue is needed, either one forgets how to carry out the operation or one becomes flustered, especially in very emergency situations. If operation is performed poorly or incorrectly, there may induce failure of tire repair and extremely high potential concerns about security.

### SUMMARY OF THE INVENTION

The present invention provides an inflator intelligent tire repair control method, of which steps comprise:

(1) providing an inflator, wherein the inflator comprises a control circuit and at least one inflation motor, the control circuit being pre-set with a lowest tire pressure judgement value, a highest tire pressure judgement value, and a pressure drop judgement value, the control circuit being adapted to allow an operator to self-set a preset tire pressure value, the inflator being mountable with a tire repair chemical can;

(2) the inflator (being supplied with electrical power), wherein the inflator is connected to a power source and is supplied with electrical power, and at this time, the control circuit is operated to detect an initial tire pressure of a preset tire before the inflation motor is not yet activated for being recorded as a first tire pressure value;

(3) activating the inflation motor, wherein after the recording of the first tire pressure value, the control circuit controls the inflation motor to activate for charging air into the tire, and at this time, the control circuit carries out re-detection of a tire pressure of the tire to be recorded as a second tire pressure value;

(4) the control circuit calculating a pressure difference and implementing a judgement procedure: the control circuit obtaining the pressure difference by subtracting the first tire pressure value from the second tire pressure value, the judgement procedure comprising the control circuit executing an inflation mode when the pressure difference is less than or equal to the lowest tire pressure judgement value; and the control circuit executing a tire repair mode when the pressure difference is greater than the lowest tire pressure judgement value and less than the highest tire pressure judgement value;

(5) the inflation mode, wherein the control circuit controls the inflation motor to activate for charging air into the tire; and in the inflation mode, when the control circuit detects the tire pressure of the tire is greater than or equal to a self-set preset tire pressure value, the control circuit controls the inflation motor to shut down and charging air into the tire is stopped;

(6) the tire repair mode, wherein the control circuit controls the inflation motor to activate for charging air into the tire; in the tire repair mode, the control circuit is not limited by the preset tire pressure value of the inflation mode and is automatically switched to execution of the inflation mode when the pressure difference becomes less than or equal to the lowest tire pressure judgement value.

Thus, the inflator realizes an automatic switching mechanism for the inflation mode and the tire repair mode.

The feature of the present invention is that the control circuit is used to first detect the tire pressure to be recorded as the first tire pressure value before the inflation motor of the inflator is activated; then, after the inflation motor of the inflator is activated, the tire pressure is re-detected to be recorded as the second tire pressure value; when the pressure difference of subtracting the second tire pressure value from the first tire pressure value is less than or equal to a lowest tire pressure judgement value, this indicates the tire is just in a state of insufficiency of tire pressure, and the inflator executes the inflation mode, namely controlling the inflation motor to activate for charging air into the tire.

When the pressure difference of subtracting the first tire pressure value from the second tire pressure value is greater than the lowest tire pressure judgement value and less than a highest tire pressure judgement value, this indicates the inflator is externally connected to or directly mounted with a tire repair chemical can, and the inflator executes the tire repair mode; after the tire repair mode is completed, switching to the inflation mode is automatically performed to thereby provide, in a perfect sense, the inflator with an automatic judgment and switching mechanism for the inflation mode and the tire repair mode to avoid failure of rescue of tire repair operation and potential safety concerns in case of poor or incorrect operation by the user.

### BRIEF DESCRIPTION OF THE DRAWINGS

FIG. 1 is an illustrative mounting structure diagram of an inflator and a tire repair chemical can in an inflator intelligent tire repair control method according to the present invention.

FIG. 2 is another illustrative mounting structure diagram of an inflator and a tire repair chemical can in an inflator intelligent tire repair control method according to the present invention.

FIG. 3 is a flow chart of an inflator intelligent tire repair control method according to the present invention.

### DETAILED DESCRIPTION OF THE PREFERRED EMBODIMENTS

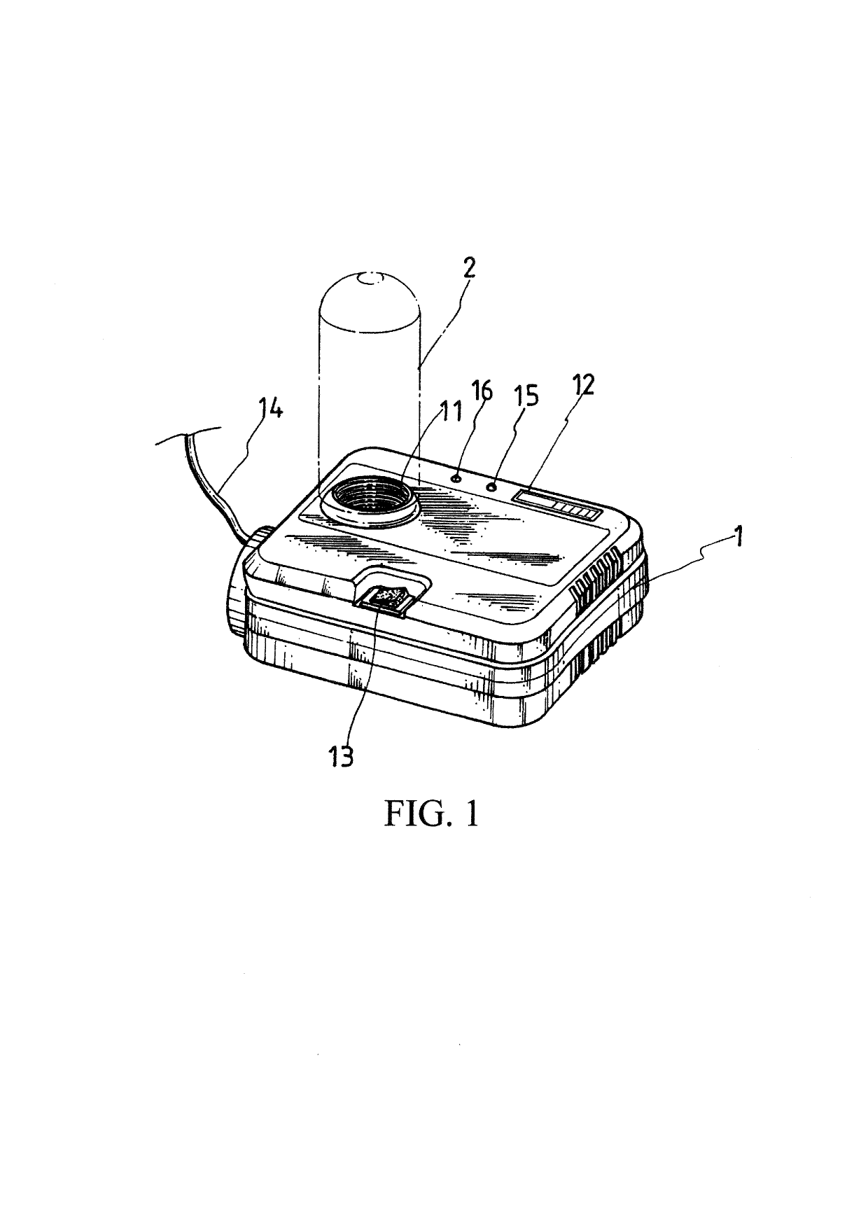

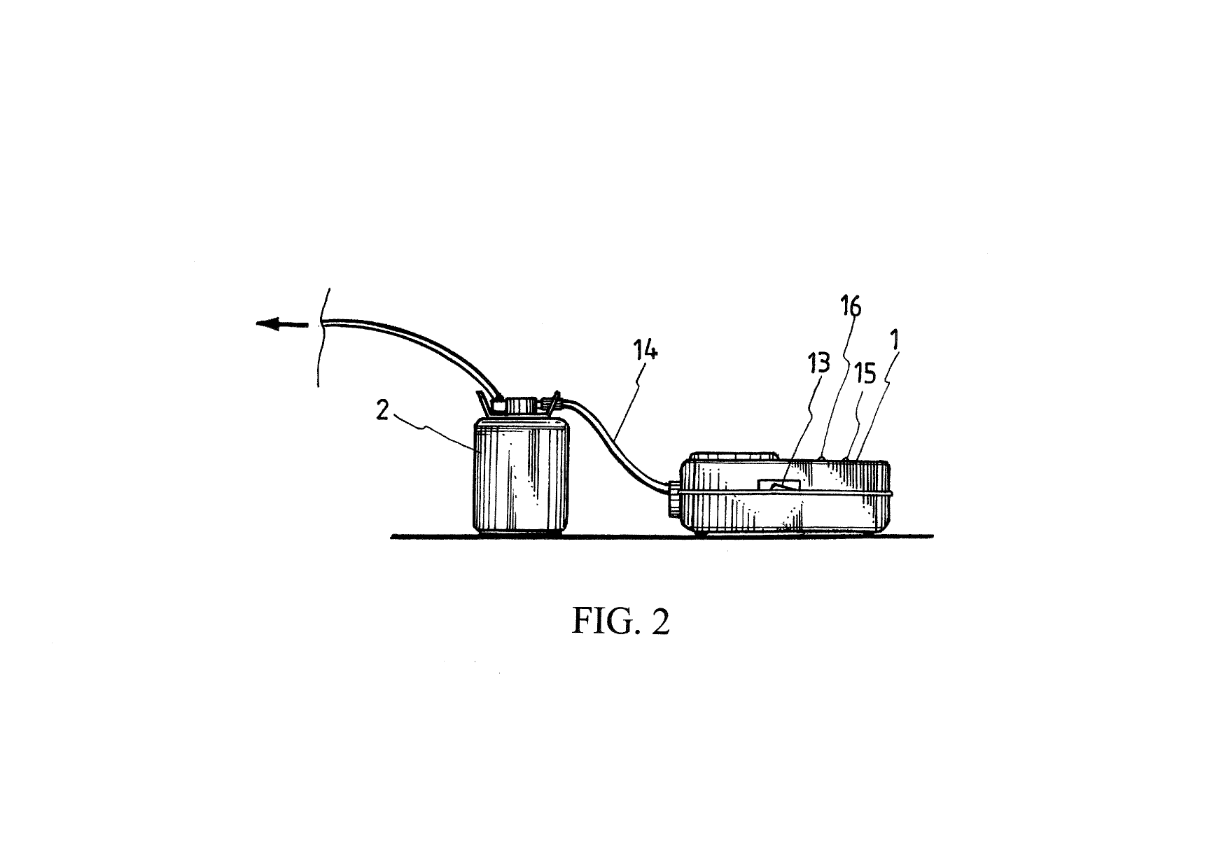

Referring to FIGS. 1 and 2, the present invention discloses an inflator intelligent tire repair control method. An inflator 1 is provided, in the interior thereof, with a control circuit and at least one inflation motor. The control circuit is electrically connected with the inflation motor, and the control circuit controls the inflation motor to operate or shut down. The inflator 1 is provided with a pressure gauge 12 and a control switch 13. The inflator 1 is provided with an air charging tube 14, and the air charging tube 14 comprises an air charging connector (not shown in the drawings). The air charging connector is connectable with a nozzle of a tire. The control circuit is electrically connected with the control switch 13 and is provided with an inflation mode indication light 15 and a tire repair mode indication light 16.

The inflator 1 may be directly mounted with a tire repair chemical can 2. For example, the inflator 1 is provided with a tire repair chemical mounting hole 11, and the tire repair chemical can 2 is mounted to the tire repair chemical mounting hole 11 as shown in FIG. 1; or in another example, the inflator 1 is connected by the air charging tube 14 to an external tire repair chemical can 2 as shown in FIG. 2. However, the connection between the inflator 1 and the tire repair chemical can 2 is not a feature of the present invention and further description will be omitted herein.

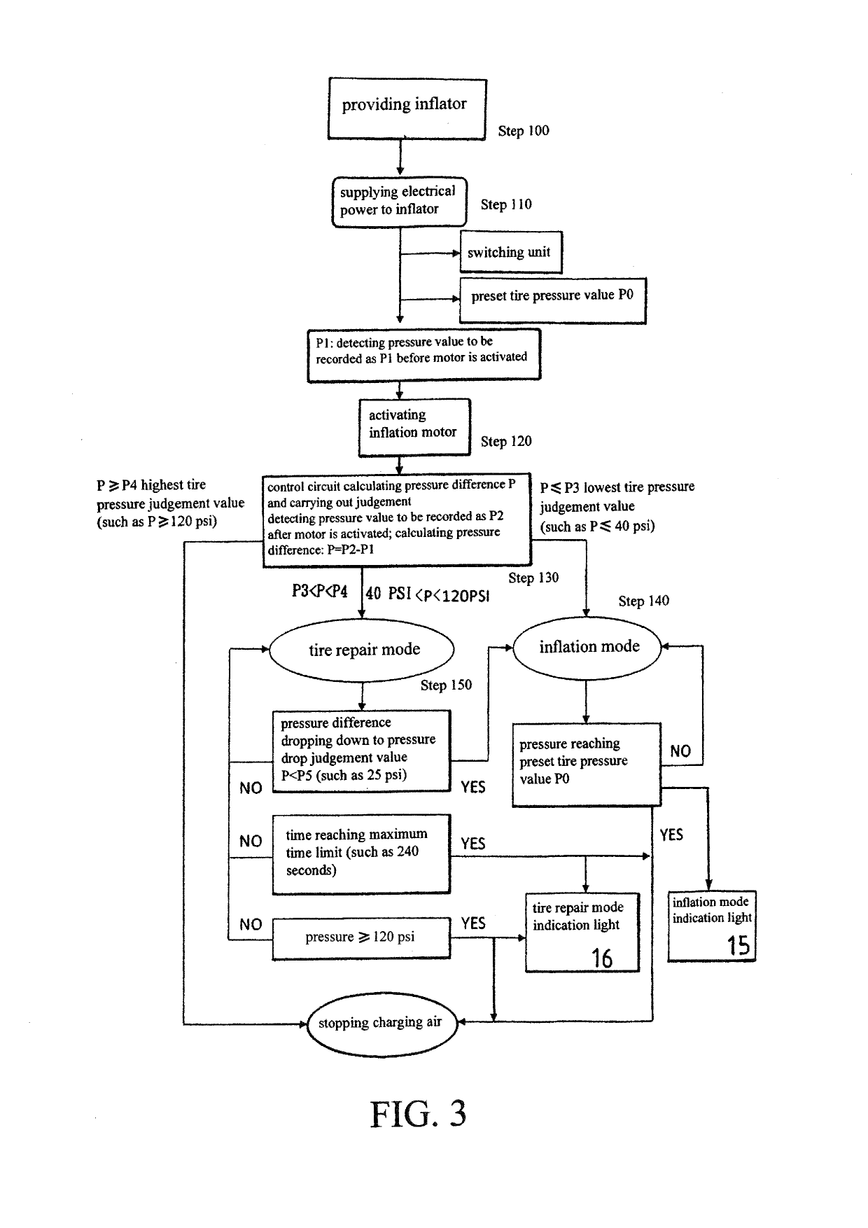

As shown in FIG. 3, the inflator intelligent tire repair control method according to the present invention comprises the following steps:

Step 100: providing an inflator 1, wherein the inflator 1 comprises a control circuit and at least one inflation motor, and the control circuit is preset with a lowest tire pressure judgement value P3 (such as 40 psi) and a highest tire pressure judgement value P4 (such as 120 psi), and a pressure drop judgement value (such as 25 psi), and the control circuit allows a user to set up a preset tire pressure value P0 (such as being set as 35 psi), and wherein the inflator 1 can be provided, in an external connection manner or directly connected therewith, with a tire repair chemical can 2 mounted thereto. The control circuit of the inflator 1 is provided with a switching function for multiple types of tire pressure units (such as psi, kPa, bar, kg/cm2).

Step 110: supplying electrical power to the inflator 1, wherein the inflator 1 is connected to a power source and is turned on, and at this time, the control circuit controls the inflation motor not activated to operation, and the operator may first carry out a pressure unit switching operation to set in advance a preset tire pressure value P0(such as being set as 35 psi) for a tire, and to carry out detection of an initial tire pressure before the circuit controls the inflation motor not activated to operation to record as a first tire pressure value P1; for example a power cable of the inflator 1 being connected to an automobile power supply hole to supply electrical power to the inflator 1, and an air charging tube of the inflator 1 being connected to a nozzle of a tire to allow the control circuit to detect an initial tire pressure of the tire, recorded as a first tire pressure value P1.

Step 120: activating the inflation motor, wherein after the recording of the first tire pressure value P1 in Step 110, the control circuit controls the inflation motor to activate for charging air into the tire, and the control circuit detects again the tire pressure of the tire to be recorded as a second tire pressure value P2; wherein in Step 120, when the control circuit controls the inflation motor to activate for charging air into the tire, the control circuit is preset with a first waiting time (for example the first waiting time being 1-5 seconds), and is operable, after lapse of the preset first waiting time, to detect the tire pressure of the tire to be recorded as the second tire pressure value P2.

Step 130: the control circuit calculating a pressure difference P and carrying out a judgement procedure, wherein the control circuit subtracts the first tire pressure value P1 from the second tire pressure value P2 to obtain a difference, which is the pressure difference P; and at this time, the control circuit carries out the judgement procedure according to the pressure difference P so obtain, wherein the judgement procedure comprises:

(1) for the pressure difference P being less than or equal to a lowest tire pressure judgement value P3 (such as 40 psi), the control circuit executing an inflation mode of Step 140;

(2) for the pressure difference P being greater than the lowest tire pressure judgement value P3 (such as 40 psi) and less than a highest tire pressure judgement value P4 (such as 120 psi), the control circuit executing a tire repair mode of Step 150; and

(3) for the pressure difference P being greater than or equal to the highest tire pressure judgement value P4 (such as 120 psi), the control circuit controlling the inflation motor to shut down, namely stopping charging air.

Step 140: inflation mode, wherein the control circuit controls the inflation motor to activate for charging air into the tire; during the course of execution of the inflation mode, when the control circuit detects the tire pressure of the tire reaches a self-set preset tire pressure value P0 (such as 35 psi), the control circuit controls the inflation motor to stop operation, namely the inflator 1 stops charging air into the tire. In the inflation mode, the control circuit continuously detects if the value of the tire pressure reaches the preset tire pressure value P0 (such as 35 psi), and if the charged air reaches the preset tire pressure value P0 (such as 35 psi), a prompt is issued by the inflation mode indication light 15 to indicate and inform the operator.

Step 150: tire repair mode, wherein the control circuit controls the inflation motor to activate to charge air into the tire; for the tire repair mode, when the pressure difference P is greater than the lowest tire pressure judgement value P3 (such as 40 psi) and less than the highest tire pressure judgement value P4 (such as 120 psi), the operation enters the tire repair mode, and a prompt is issued by the tire repair mode indication light 16 to indicate and inform the operator; during execution, it is not constrained by the preset tire pressure value P0 (such as 35 psi) of the tire in the inflation mode; when the tire repair mode continues for a predetermined period of time, as the tire repair chemical is completely filled and the pressure difference P drops down to be lower than a pressure drop judgement value P5 (such as being set as 25 psi), the control circuit automatically switches to the inflation mode, and a prompt is issued by the inflation mode indication light 15 to indicate and inform the operator; when the pressure continuously rises to the preset tire pressure value P0, air charging is automatically stopped and the tire repair mode is complete.

In the tire repair mode of Step 150, if the tire repair mode continues for a period of time that reaches a maximum time limiting value (such as 240 seconds) preset by the control circuit, the control circuit controls the inflation motor to automatically stop operation; and at this time, a prompt is issued by the tire repair mode indication light 16 (to indicate that the tire repair mode is not complete) to indicate and inform the operator; further, during the course of execution of the tire repair mode in Step 150, when the pressure is greater than or equal to the highest tire pressure judgement value P4 (such as 120 psi), similarly, the control circuit controls the inflation motor to automatically stops operation; and in this time, a prompt is issued by the tire repair mode indication light 16 for indication (to indicate the tire repair mode is not complete) to indicate and inform the operator.

Thus, in the tire repair mode of Step 150, the control circuit carries out judgement regarding if an ending-tire-repair setting is met, wherein the ending-tire-repair setting is as follows:

(1) In the tire repair mode, when the pressure difference P is less than the pressure drop judgement value P5 (such as being set as 25 psi), it indicates that the tire repair mode be stopped and automatically switching to execution of the inflation mode of Step 140; and at this time, a prompt is issued by the inflation mode indication light 15 (in a state of being inflated) to indicate and inform the operator.

(2) In the tire repair mode, the control circuit is preset with a second waiting time (such as the second waiting time being 240 seconds), and after lapse of the second waiting time, the air charging operation is automatically shut down, and at this time, a prompt is issued by the tire repair mode indication light 16 (the tire repair mode being not complete) to indicate and inform the operator.

(3) In the tire repair mode, when the pressure is greater than the highest tire pressure judgement value P4 (such as 120 psi), the control circuit controls the inflation motor to automatically shut down; and at this time, a prompt is issued by the tire repair mode indication light 16 (the tire repair mode being not complete) to indicate and inform the operator.

In the tire repair mode, the control circuit continuously detects the second tire pressure value P2 to consistently judge if the pressure different value P is less than the lowest tire pressure judgement value P3 and greater than the highest tire pressure judgement value P4.

Thus, through the above steps, an automatic switching mechanism for the inflation mode and the tire repair mode can be realized in the inflator 1.

When the user notices the tire pressure of a tire is insufficient or notices the tire deflates as being punctured, the user only needs to connect the inflator 1 to a power source (such as an automobile power supply) and connect the air charging tube of the inflator 1 to a nozzle of the tire to get ready for executing the inflation mode or the tire repair mode; namely the feature of the present invention is that an operator may use the time when electrical power is supplied to the inflator 1 but the control circuit controls the inflation motor not to be activated to self-set a preset tire pressure value P0, and the control circuit first detects the tire pressure to be recorded as the first tire pressure value P1; then, the control circuit controls the inflation motor to activate and then detects the tire pressure to be recorded as the second tire pressure value P2; at this time, the control circuit uses the first tire pressure value P1 and the second tire pressure value P2 as data for judgement, namely for the pressure difference P of subtracting the first tire pressure value P1 from the second tire pressure value P2 being less than a lowest tire pressure judgement value P3, this indicates the tire is just in a state of insufficiency of tire pressure, and the inflator 1 only executes the inflation mode and controls the inflation motor to activate for charging air into the tire; in case that the tire is punctured and deflates, rescue for tire repair can be carried out by mounting a tire repair chemical can, and the judgment is made as follows: for the pressure difference P of subtracting the first tire pressure value P1 from the second tire pressure value P2 being greater than the lowest tire pressure judgement value P3 and less than a highest tire pressure judgement value P4, this indicates the inflator 1 is in a state of being connected to or being mounted with the tire repair chemical can 2 (wherein between the tire repair chemical can 2 so connected or mounted and the inflator 1, due to the tire repair chemical can 2 having a pneumatically openable valve, there is an impeding relationship, and the impeding relationship is P3<P<P4), and the inflator 1 automatically executes the tire repair mode, and after the tire repair mode is completed, it is automatically performed for switching to the inflation mode, so that the inflator 1 has an intelligent judgement and switching mechanism for the inflation mode and the tire repair mode to avoid poor or incorrect operation by the user, which may lead to failure of the tire repair operation and potential safety concerns.

I claim:

1. An inflator intelligent tire repair control method, of which steps comprise:
(1) providing an inflator, wherein the inflator comprises a control circuit and at least one inflation motor, the control circuit being pre-set with a lowest tire pressure judgement value, a highest tire pressure judgement value, and a pressure drop judgement value, the control circuit being adapted to allow an operator to self-set a preset tire pressure value, the inflator being mountable with a tire repair chemical can;
(2) supplying electrical power to the inflator, wherein the inflator is connected to a power source and powered on and the control circuit controls the inflation motor not to activate, so that detection of an initial tire pressure of a tire is carried out first to be recorded as a first tire pressure value;
(3) activating the inflation motor, wherein the control circuit controls the inflation motor to activate for charging air into the tire, and the control circuit carries out re-detection of a tire pressure of the tire to be recorded as a second tire pressure value;
(4) the control circuit calculating a pressure difference and implementing a judgement procedure:
the control circuit obtaining the pressure difference by subtracting the first tire pressure value from the second tire pressure value, the judgement procedure comprising the control circuit executing an inflation mode when the pressure difference is less than or equal to the lowest tire pressure judgement value; and the control circuit executing a tire repair mode when the pressure difference is greater than the lowest tire pressure judgement value and less than the highest tire pressure judgement value;
(5) the inflation mode, wherein when the control circuit detects the tire pressure of the tire reaches the preset tire pressure value, charging air into the tire is stopped;
(6) the tire repair mode, which is not limited by the tire the preset tire pressure value of the inflation mode, the control circuit judging if an ending-tire-repair setting is met, wherein the ending-tire-repair setting is as follows:
in the tire repair mode, when the pressure difference is less than the pressure drop judgement value, stopping the tire repair mode and automatically switching to execution of the inflation mode;
in the tire repair mode, the control circuit being pre-set with a second waiting time, and after lapse of the second waiting time, automatically stopping operation of charging air;
in the tire repair mode, when the pressure difference is greater than the highest tire pressure judgement value, the control circuit controlling the inflation motor to automatically shut down;
(7) the inflator realizing an automatic switching mechanism for the inflation mode and the tire repair mode.

2. The inflator intelligent tire repair control method according to claim 1, wherein in the step of activating the inflation motor, when the control circuit controls the inflation motor to activate for charging air into the tire, the control circuit is pre-set with a first waiting time, and after lapse of the first waiting time, detection of the tire pressure of the tire is re-performed to be recorded as the second tire pressure value.

3. The inflator intelligent tire repair control method according to claim 1, wherein the control circuit comprises a function of switching among multiple types of tire pressure units.

4. The inflator intelligent tire repair control method according to claim 1, wherein the inflation mode comprises an inflation mode indication light for prompt purpose.

5. The inflator intelligent tire repair control method according to claim 1, wherein the tire repair mode comprises a tire repair mode indication light for prompt purpose.

6. The inflator intelligent tire repair control method according to claim 1, wherein the inflator is connectable with a tire repair chemical can, and the inflator is connected by means of a connection tube with the tire repair chemical can installation.

7. The inflator intelligent tire repair control method according to claim 1, wherein in the tire repair mode, when the control circuit detects the pressure difference is greater than or equal to the highest tire pressure judgement value, the control circuit controls the inflation motor to shut down.

8. The inflator intelligent tire repair control method according to claim 1, wherein in the inflation mode, the control circuit constantly detect if the tire pressure value reaches the preset tire pressure value.

9. The inflator intelligent tire repair control method according to claim 1, wherein in the tire repair mode, the control circuit constantly detects the second tire pressure value to consistently judge if the pressure difference value is less than the lowest tire pressure judgement value and greater than the highest tire pressure judgement value.
